(19) United States
(12) Patent Application Publication
(10) Pub. No.: US 2010/0026256 A1
(43) Pub. Date: Feb. 4, 2010

(54) Switching regulator and control method thereof

(76) Inventors: Jing-Meng Liu, Jubei City (TW); An-Tung Chen, Pingjen City (TW); Fu-Shiang Lai, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,185

(22) Filed: Nov. 13, 2008

(30) Foreign Application Priority Data
Jul. 31, 2008 (TW) 097129111

(51) Int. Cl. G05F 1/10

(52) U.S. Cl. 323/282

(57) ABSTRACT

A switching regulator may operate in a synchronous mode or an asynchronous mode. When the load current is higher than a threshold, the switching regulator switches a pair of serially connected high side and low side switches with a pulse width modulation signal. When the load current is lower than the threshold, the pulse width modulation signal is blocked not to switch the low side switch, the switching regulator switches only the high side switch with the pulse width modulation signal, the low side switch remains off, and a diode serially connected to the high side switch acts as a rectifier.

### FIELD OF THE INVENTION

The present invention is related generally to a switching regulator and, more particularly, to a circuit and method for maintaining high efficiency over broad current ranges in a switching regulator.

### BACKGROUND OF THE INVENTION

Switching regulators can be roughly classified into synchronous ones and asynchronous ones. When a switching regulator operates in synchronous mode, the conduction loss is low in heavy load current. As the load current decreases, the switching loss is dominant in efficiency. On the contrary, a switching regulator operating in asynchronous mode when load current is low will enter pulse skipping (PSK) mode to reduce switching loss. But in heavy load current, conduction loss is dominant. Therefore, it may conclude that synchronous mode has good efficiency in heavy load and poor efficiency in light load, and asynchronous mode has good efficiency in light load but poor efficiency in heavy load. For more detail, FIG. 1 shows a traditional synchronous switching regulator 10, which includes a controller 12 to switch a high side switch 14 and a low side switch 16 connected in series between a power input receiving an input voltage Vin and a ground terminal GND to supply an output voltage Vout and a load current IRL for a load RL. The high side switch 14 and the low side switch 16 are both power transistors and have relatively low on-resistances thereof, and therefore, when the load current IRL is high, i.e. in heavy load, conduction loss caused by the power switches 14 and 16 is small. However, when the load current IRL is low, i.e. in light load, switching loss of the power switches 14 and 16 will significantly decrease the efficiency of the switching regulator 10. FIG. 2 shows a traditional asynchronous switching regulator 20, in which a switch 24 and a diode 26 are connected in series between a power input receiving an input voltage Vin and a ground terminal GND, and a controller 22 switches the switch 24 to supply an output voltage Vout and a load current IRL for a load RL. The switching regulator 20 will enter PSK mode to reduce switching loss when the load current IRL is low. However, when the load current IRL is high, since the diode 26 has relatively high on-resistance, its conduction loss will significantly decrease the efficiency of the switching regulator 20.

U.S. Pat. No. 7,064,531 to Zinn provides a pulse width modulation (PWM) regulator which may enter a low dropout (LDO) standby mode to reduce switching loss when its load current is low. Even though this regulator can get better efficiency in LDO mode than in synchronous mode when load current is low, the efficiency of LDO mode is still not good enough and is limited to the characteristic of LDO.

U.S. Pat. No. 5,481,178 to Wilcox et al. provides a control circuit and method for a switching regulator, which will detect the current of the low side switch, and turn the low side switch off when the current is zero. By this way, it can prevent negative current and enters PSK mode when load current is low. Although it can get high efficiency over broad current ranges, the drawback is as operating frequency of the system is higher, e.g., over 8 MHz, it is very hard to implement the zero current detecting circuit which disables the NMOS at the right level (zero current). When the low side switch turns off at higher current levels, the current will flow through the parasitic diode of the low side switch. It will cause large IR drop loss and reverse recovery current loss to reduce the power efficiency. If the low side switch turns off at negative current levels, it will draw power from load. So this art is hard to switch at right current level as operating frequency is high and maintaining high efficiency at low current level.

Therefore, it is desired a switching regulator having both the advantages of synchronous and asynchronous modes.

### SUMMARY OF THE INVENTION

An object of the present invention is to provide a switching regulator which operates in synchronous mode at high load current and operates in asynchronous mode at low load current. Therefore, the switching regulator combines the advantages of two modes to get high efficiency over broad current ranges.

According to the present invention, a switching regulator includes a high side switch, a low side switch and a diode. The high side and low side switches are serially connected by a phase node to operate as a synchronous converter, and the high side switch and diode are serially connected by the phase node to operate as an asynchronous converter. When the load current is higher than a threshold, the switching regulator operates with synchronous mode in which the high side and low side switches are switched by a pulse width modulation. When the load current is lower than the threshold, the switching regulator operates with asynchronous mode in which the low side switch remains off and only the high side switch is switched by the pulse width modulation. In the asynchronous mode, the diode acts as a rectifier.

Since the switching regulator operates in synchronous mode when load current is high and operates in asynchronous mode when load current is low, it has the advantages of both synchronous and asynchronous modes, and gets high efficiency over broad current ranges. Moreover, because it is unnecessary for the switching regulator to detect the current level in each cycle, the switching regulator can accurately detect the current level even when the operating frequency is increased.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a circuit diagram of a traditional synchronous switching regulator;

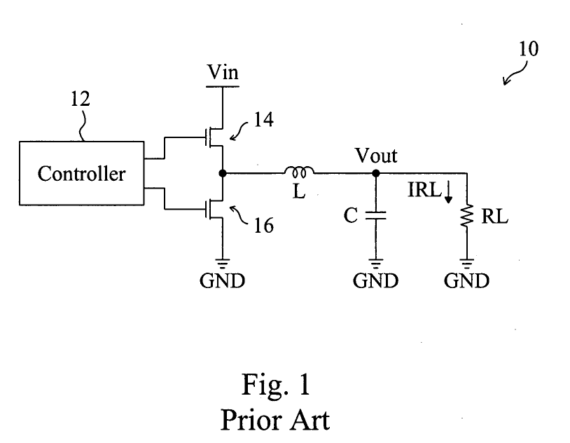

FIG. 2 is a circuit diagram of a traditional asynchronous switching regulator;

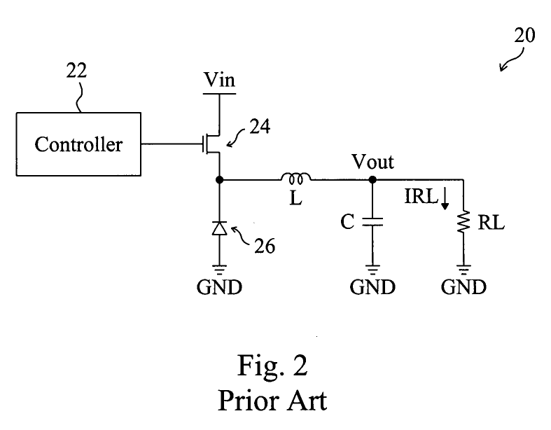

FIG. 3 is a circuit diagram of a switching regulator according to the present invention;

FIG. 4 is a diagram to show the efficiency of the switching regulator shown in FIG. 3 when operating in synchronous mode and in asynchronous mode; and

FIG. 5 is an embodiment for the light load detector shown in FIG. 3.

### DETAILED DESCRIPTION OF THE INVENTION

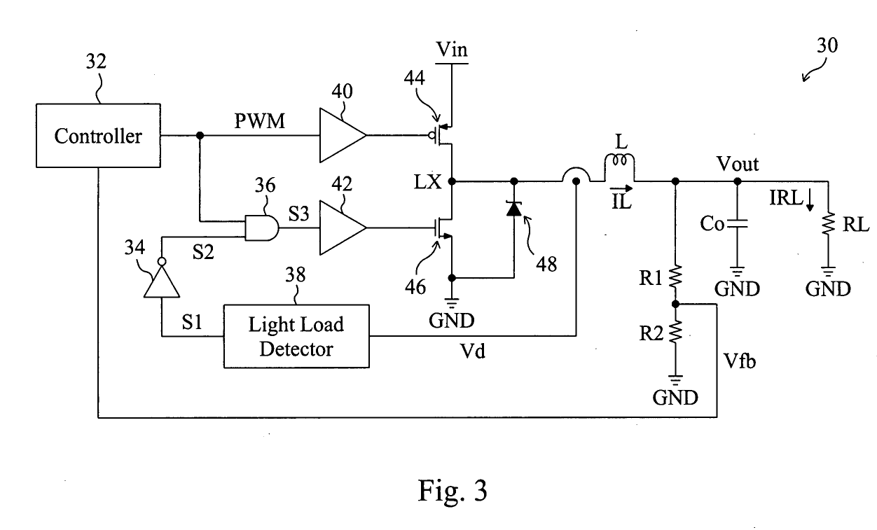

According to the present invention, as shown in FIG. 3, a switching regulator 30 includes a high side switch 44, a low side switch 46 and a diode 48 so configured that the combination of the high side switch 44 and low side switch 46 may operate as a synchronous converter, and the combination of the high side switch 44 and diode 48 may operate as an asynchronous converter, in order to convert an input voltage Vin to an output voltage Vout. Resistors R1 and R2 are serially connected between a power output Vo and a ground terminal GND as a voltage divider to divide the output voltage Vout to produce a feedback signal Vfb for a controller 32 which generates a pulse width modulation signal PWM. On the other hand, a light load detector 38 monitors the load current IRL by detecting the inductor current IL in an inductor L to assert a light load signal S1, an inverter 34 inverts the light load signal S1 to be a signal S2, and an AND gate 36 determines a signal S3 according, to the signals PWM and S2. Drivers 40 and 42 drive the high side switch 44 and low side switch 46 in response to the signals PWM and S3, respectively.

The diode 48 may be integrated with the switches 44 and 46 on a single chip or a discrete component connected between the phase node LX and ground terminal GND. Preferably, the diode 48 is a Schottky diode. The switches 44 and 46 employ large MOS transistors to supply medium and high currents IRL to the load RL in synchronous mode, and the diode 48 has small size to sustain low current in asynchronous mode.

When the load current IRL is high, the light load signal S1 will be logic low, and thus the signal S3 will be the signal PWM. In this case, the drivers 40 and 42 will switch the switches 44 and 46 according to the signal PWM, i.e. the switching regulator 30 operates in synchronous mode. Since the switches 44 and 46 are both power transistors, they have relatively low on-resistances and thereby have relatively small conduction loss. As a result, the switching regulator 30 may have good efficiency when it operates at high load current IRL. For low load current IRL or standby mode, the light load signal S1 will be logic high, and thus the signal S2 is logic low to blank the signal PWM by the AND gate 36. In this case, the driver 40 may still switch the high side switch 44 according to the pulse width modulation signal PWM, while the low side switch 46 will remain off. In other words, the switching regulator 30 operates in asynchronous mode with the high side switch 44 and diode 48. Since the diode 48 prevents negative current and the switching regulator 30 is capable of entering a PSK mode to reduce switching loss, the switching regulator 30 still have good efficiency when it operates at low load current IRL. As long as an adequate point to switch the switching regulator 30 between synchronous mode and asynchronous mode is selected, the switching regulator 30 can get good efficiency whether the load current IRL is high or low. Moreover, since the switching regulator 30 does not need to detect the zero point of the inductor current IL in each cycle to turn off the low side switch 46, it is allowed to function efficiently even the switching regulator 30 operates with high switching frequency.

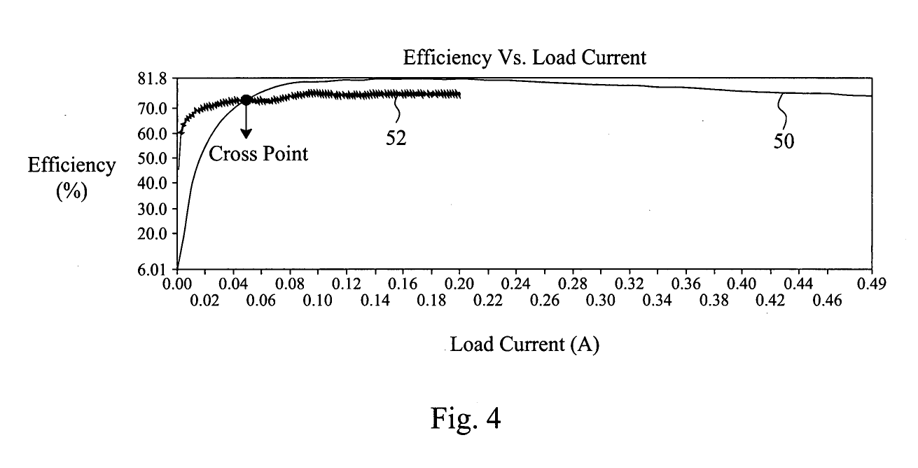

FIG. 4 shows the efficiency of the switching regulator 30 when the load current IRL varies from low to high, in which curves 50 and 52 represent the efficiency of the switching regulator 30 operating in synchronous mode and in asynchronous mode, respectively. As shown in FIG. 4, a cross point exists between the curves 50 and 52. The cross point may be a good switching point for the switching regulator 30 to be switched between the synchronous mode and asynchronous mode. Before the cross point, the switching regulator 30 is advantageously to operate with asynchronous mode, and the synchronous mode is advantageous after the cross point. When the load current IRL is higher than the level corresponding to the cross point, the switching regulator 30 has better efficiency by operating in synchronous mode, and when the load current IRL is lower than that level corresponding to the cross point, the switching regulator 30 will have better efficiency by operating in asynchronous mode. Thus, the switching regulator 30 can be set in such a way that when the load current IRL is higher than the level corresponding to the cross point, the light load signal S1 produced by the light load detector 38 will be logic low to switch the switching regulator 30 to operate in synchronous mode and when the load current IRL is lower than the level corresponding to the cross point, the light load signal S1 will be logic high to switch the switching regulator 30 to operate in asynchronous mode. Therefore, the switching regulator 30 will have good efficiency over a broad current range.

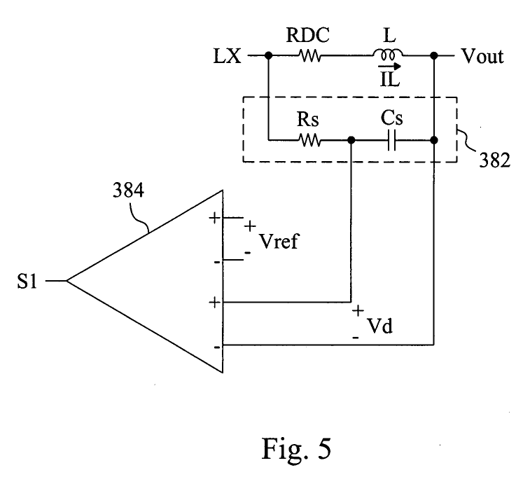

In the switching regulator 30, the light load detector 38 monitors the load current IRL by detecting the inductor current IL. Since there are many developed approaches for detecting the inductor current IL, the circuit shown in FIG. 5 is only for example. In the light load detector of FIG. 5, an RC circuit 382 composed by serially connected resistor Rs and capacitor Cs is shunt to the inductor L to extract the DC component of the inductor current IL to produce a voltage Vd, and a comparator 384 compares the detected voltage Vd with a reference voltage Vref to generate the low load signal S1. In FIG. 5, the resistor RCD represents the parasitic resistor of the inductor L to illustrate how the RC circuit 382 could detect the DC component of the inductor current IL.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A switching regulator for providing a load current, comprising:
a high-side switch;
a low-side switch serially connected to the high side switch to be configured together with the high side switch to be a synchronous converter; and
a diode connected serially connected to the high side switch to be configured together with the high side switch to be an asynchronous converter;
wherein the switching regulator operates in a synchronous mode with the synchronous converter when the load current is higher than a threshold, and operates in an asynchronous mode with the asynchronous converter when the load current is lower than the threshold.

2. The switching regulator of claim 1, wherein the diode comprises a Schottky diode.

3. The switching regulator of claim 1, further comprising a controller connected to the high side and low side switches to generate a pulse-width modulation signal to switch the high side and low side switches in the synchronous mode.

4. The switching regulator of claim 1, further comprising a controller connected to the high side switch to generate a pulse width modulation signal to switch only the high side switch in the asynchronous mode.

5. The switching regulator of claim 4, further comprising a light load detector connected to the controller to generate a light load signal to block the pulse width modulation signal so as not to switch the low side switch when the load current is lower than the threshold.

6. A control method for a switching regulator to provide a load current, comprising the steps of:
monitoring the load current; and
switching a pair of serially connected high side and low side switches by a pulse width modulation signal to operate the switching regulator in a synchronous mode when the load current is higher than a threshold; and
switching only the high side switch by the pulse width modulation signal to operate the switching regulator in an asynchronous mode when the load current is lower than the threshold;
wherein in the asynchronous mode, the low side switch remains off and a diode serially connected to the high side switch acts as a rectifier.

7. The control method of claim 6, further comprising the step of blocking the pulse width modulation signal so as not to switch the low side switch when the load current is lower than the threshold.
